(19) United States
(12) Patent Application Publication
(10) Pub. No.: US 2024/0304856 A1
(43) Pub. Date: Sep. 12, 2024

(54) SOLID ELECTROLYTE AND LITHIUM SECONDARY BATTERY INCLUDING THE SAME

(71) Applicant: ELECTRONICS AND TELECOMMUNICATIONS RESEARCH INSTITUTE, Daejeon (KR)

(72) Inventors: Seokyoon YOON, Daejeon (KR); YOUNG SAM PARK, Daejeon (KR); Seok Hun KANG, Daejeon (KR); Jaecheol CHOI, Daejeon (KR); Dong Ok SHIN, Daejeon (KR); Young-Gi LEE, Daejeon (KR); Ju Young KIM, Daejeon (KR); Jinyoung KIM, Daejeon (KR)

(21) Appl. No.: 18/596,329

(22) Filed: Mar. 5, 2024

(30) Foreign Application Priority Data
Mar. 7, 2023 (KR) 10-2023-0030160

(51) Int. Cl. H01M 10/0562; H01M 10/052; H01M 10/058; H01M 50/403; H01M 50/44

(52) U.S. Cl. CPC H01M 10/0562; H01M 10/052; H01M 10/058; H01M 50/403; H01M 50/44; H01M 2300/0091

(57) ABSTRACT

Provided is a lithium secondary battery including a first electrode, a second electrode spaced apart from the first electrode, a solid electrolyte disposed between the first electrode and the second electrode, wherein the solid electrolyte includes a fibril and a plurality of sulfide particles, the fibril includes polytetrafluoroethylene, the fibril surrounds at least some of the sulfide particles or is in contact with at least some of the sulfide particles.

### CROSS-REFERENCE TO RELATED APPLICATIONS

This U.S. non-provisional patent application claims priority under 35 U.S.C. § 119 of Korean Patent Application No. 10-2023-0030160, filed on Mar. 7, 2023, the entire contents of which are hereby incorporated by reference.

### BACKGROUND

The present disclosure herein relates to a lithium secondary battery, and more particularly, to a solid electrolyte and a lithium secondary battery including the same.

Secondary batteries may include lithium batteries. The lithium batteries have been more widely applied lately. For example, the lithium batteries are widely used as a power source for electric vehicles (EV) and energy storage systems (ESS). An increase in the amount of flame retardant may lead to cost and performance issues.

Electrolytes in the lithium batteries may include liquid electrolytes or solid electrolytes. In the case of liquid electrolytes, flammability and combustibility may hurt the stability of lithium secondary batteries. Various studies are underway to overcome the issue.

### SUMMARY

The present disclosure provides a sulfide-based solid electrolyte composition having improved thermal stability and electrochemical properties, and a lithium battery electrolyte including the same.

The present disclosure also provides a lithium battery having improved electrochemical properties.

The present disclosure is not limited to the technical problems described above, and those skilled in the art may understand other technical problems from the following description.

An embodiment of the inventive concept provides a lithium secondary battery including a first electrode, a second electrode spaced apart from the first electrode, a solid electrolyte disposed between the first electrode and the second electrode, wherein the solid electrolyte includes a fibril and a plurality of sulfide particles, the fibril includes polytetrafluoroethylene, the fibril is in contact with at least some of the sulfide particles, the polytetrafluoroethylene is present at a weight of about 0.1% to about 2% of a weight of the sulfide, and the solid electrolyte has a thickness of about 10 μm to about 99 μm.

In some embodiments, the fibril may have a thickness of less than about 0.5 μm and have a thin thread shape.

In some embodiments, the sulfide may include LiPSCl sulfide.

In some embodiments, the solid electrolyte may be prepared through a dry manufacturing method.

In some embodiments, the first electrode may be a negative electrode, and the second electrode may be a positive electrode.

In some embodiments, the second electrode may include a positive electrode active material and sulfide particles, and the second electrode may include the same sulfide particles as the solid electrolyte.

In some embodiments, the fibril may have at least any one of a straight shape, a curved shape, or a curved shape with diverging branches.

In some embodiments, the sulfide may be Li₆PS₅Cl, the polytetrafluoroethylene may be in an amount of 0.5 wt % in the mixture of the sulfide and polytetrafluoroethylene, and the sulfide may be in an amount of 99.5 wt % in the mixture of the sulfide and polytetrafluoroethylene.

In an embodiment of the inventive concept, a method for manufacturing a lithium secondary battery includes preparing a first electrode, preparing a second electrode, preparing a solid electrolyte, and disposing the solid electrolyte between the first electrode and the second electrode, wherein the preparing of the solid electrolyte includes mixing sulfide particles and fiber powder to prepare a first mixture, applying a primary thermal grinding treatment to the first mixture to prepare a first dough, and applying a primary thermal pressure treatment to the first dough to prepare the solid electrolyte.

In some embodiments, the mixing of the sulfide particles and the fiber powder to prepare the first mixture may include mixing LiPSCl-based Li₆PS₅Cl sulfide in an amount of 99.5 wt % and polytetrafluoroethylene in an amount of 0.5 wt %.

In some embodiments, the applying the primary thermal grinding treatment to the first mixture to prepare the first dough may include grinding the first mixture at a temperature of about 60° C. to about 140° C. to prepare the first dough.

In some embodiments, the applying the primary thermal grinding treatment to the first mixture to prepare the first dough may include grinding the first mixture with a mortar and pestle at 100° C. to prepare the first mixture into dough.

In some embodiments, the applying the primary thermal pressure treatment to the first dough to prepare the solid electrolyte may include pushing the first dough into an empty space between a plurality of rotating press rolls having a temperature of about 70° C. to about 150° C.

In some embodiments, the applying the primary thermal pressure treatment to the first dough to prepare the solid electrolyte may include pushing the first dough into the empty space at least two times while reducing the size of the empty space between the press rolls.

In some embodiments, the solid electrolyte may include a fibril and a plurality of sulfide particles, the fibril may include polytetrafluoroethylene, the fibril may be in contact with at least some of the sulfide particles, the polytetrafluoroethylene may be present at a weight of about 0.1% to about 2% of a weight of the sulfide, and the solid electrolyte may have a thickness of about 10 μm to about 99 μm.

In some embodiments, the preparing of the solid electrolyte may further include applying additional pressure to the solid electrolyte after applying the primary thermal pressure treatment to the first dough to prepare the solid electrolyte, and the applying additional pressure to the solid electrolyte may include applying pressure at a pressure of about 200 MPa to about 600 MPa at about 70° C. to about 130° C.

In some embodiments, the preparing of the solid electrolyte may further include applying a unidirectional thermal pressure treatment to the first dough after applying the primary thermal grinding treatment to the first mixture to prepare the first dough, and the unidirectional thermal pressure treatment may include pressing the first dough in one direction at about 70° C. to about 130° C. to make the first dough flat.

In some embodiments, the fiber powder may include polytetrafluoroethylene powder, and the polytetrafluoroethylene powder may be present at a weight of 0.1% to 2% of a weight of the sulfide powder.

In an embodiment of the inventive concept, a method for preparing a solid electrolyte includes mixing sulfide particles and fiber powder to prepare a first mixture, applying a primary thermal grinding treatment to the first mixture to prepare a first dough, applying a unidirectional thermal pressure treatment to the first dough, applying a primary thermal pressure treatment to the unidirectional thermal pressure treated first dough to prepare a solid electrolyte, and applying additional pressure to the solid electrolyte, wherein the applying a primary thermal grinding treatment to the first mixture to prepare a first dough includes grinding the first mixture at a temperature of about 60° C. to about 140° C., the applying the unidirectional thermal pressure treatment to the first dough includes pressing the first dough in one direction at about 70° C. to about 130° C. to make the first dough flat, and the applying the primary thermal pressure treatment to the unidirectional thermal pressure treated first dough to prepare a solid electrolyte includes pushing the first dough into an empty space between a plurality of rotating press rolls having a temperature of about 70° C. to about 150° C.

In some embodiments, the solid electrolyte may have a thickness of about 27 μm or less after the applying of additional pressure to the solid electrolyte.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a cross-sectional view showing a lithium secondary battery according to an embodiment of the inventive concept;

FIG. 1B is a cross-sectional view showing a lithium secondary battery according to an embodiment of the inventive concept;

FIG. 2 is a view for describing a solid electrolyte according to an embodiment of the inventive concept, and is a view enlarging region A of FIG. 1;

FIG. 3A is a flowchart showing a method for preparing a solid electrolyte according to an embodiment of the inventive concept;

FIG. 3B is a flowchart showing a method for preparing a solid electrolyte according to an embodiment of the inventive concept;

FIG. 4 is a flowchart showing a method for manufacturing a secondary battery according to an embodiment of the inventive concept;

FIGS. 5A, 5B, and 5C are views for describing a solid electrolyte according to an embodiment of the inventive concept;

FIG. 6 is a scanning electron microscope (SEM) image of a solid electrolyte prepared according to an embodiment of the inventive concept;

FIG. 7 is a scanning electron microscope (SEM) image of a solid electrolyte prepared according to an embodiment of the inventive concept, and is a view enlarging region Q of FIG. 6;

FIG. 8 is a scanning electron microscope (SEM) image of a solid electrolyte prepared according to an embodiment of the inventive concept;

FIG. 9 is a scanning electron microscope (SEM) image of a solid electrolyte prepared according to an embodiment of the inventive concept;

FIG. 10 is a scanning electron microscope (SEM) image of a solid electrolyte prepared according to an embodiment of the inventive concept;

FIG. 11 is a graph for describing the electrical resistance and conductance properties of a solid electrolyte prepared according to an embodiment of the inventive concept;

FIG. 12 is a graph for describing the charging and discharging characteristics of a lithium secondary battery manufactured using a solid electrolyte prepared according to an embodiment of the inventive concept; and

FIG. 13 is a graph for describing the characteristics of a secondary battery including a solid electrolyte prepared according to an embodiment of the inventive concept.

### DETAILED DESCRIPTION

In order to fully understand configuration and effects of the inventive concept, preferred embodiments of the inventive concept will be described with reference to the accompanying drawings. However, the inventive concept may be embodied in different forms and variously modified and changed, and should not be constructed as limited to embodiments set forth herein. Rather, these embodiments are provided so that the inventive concept will be thorough and complete, and will fully convey the scope of the inventive concept to those skilled in the art. Those skilled in the art will appreciate that the inventive concept may be carried out in a certain suitable environment.

Terms used herein are not for limiting the inventive concept but for describing embodiments. As used herein, singular terms are intended to include plural forms as well, unless the context clearly indicates otherwise. It will be further understood that the terms “comprises” and/or “comprising”, when used ‘in this description, specify the presence of stated elements, steps, operations, and/or components, but do not preclude the presence or addition of one or more other elements, steps, operations, and/or components.

As used herein, when a film (or layer) is referred to as being on another film (or layer) or substrate, it may be directly on the other film or substrate, or intervening a third film (or layer) may be present.

Although the terms such as first, second, third, etc. are used herein to describe various regions, films (or layers), and the like, these regions, films (or layers), and the like should not be limited by these terms. These terms are used only to distinguish one region or film (or layer) from another region or film (or layer). Therefore, a film material referred to as a first film material in one embodiment may be referred to as a second film material in another embodiment. An embodiment described and exemplified herein includes a complementary embodiment thereof. Like reference numerals refer to like elements throughout.

Unless otherwise defined, the terms used in embodiments of the inventive concept may be interpreted as meaning commonly known to those skilled in the art.

Solid electrolytes may be used in secondary batteries. It is widely known that a lithium secondary battery is provided with an increase in energy density and power density when a solid electrolyte has a reduction in thickness. There are two ways mainly used for preparing a solid electrolyte, which are a dry process and a wet process. An embodiment of the inventive concept provides a sulfide solid electrolyte prepared through a dry process, and a lithium secondary battery manufactured using the sulfide solid electrolyte. More specifically, a dry-processed sulfide-based solid electrolyte having a thickness of less than about 100 μm (μm: 1 μm=10-6 μm) and containing a fibril, and a lithium secondary battery manufactured using the dry-processed sulfide-based solid electrolyte.

Hereinafter, a solid electrolyte material, a lithium battery electrolyte, and a lithium battery according to an embodiment of the inventive concept will be described with reference to the accompanying drawings.

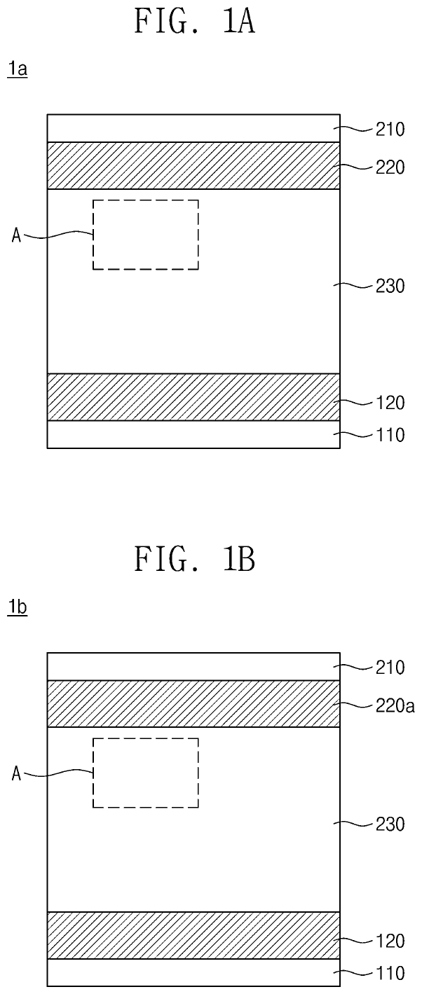

FIG. 1A is a cross-sectional view showing a lithium secondary battery according to an embodiment of the inventive concept. FIG. 1B is a cross-sectional view showing a lithium secondary battery according to an embodiment of the inventive concept.

Referring to FIG. 1A, a lithium secondary battery 1a according to an embodiment of the inventive concept may include a first current collector 110, a first electrode 120 on the first current collector 110, an electrolyte 230 on the first electrode 120, a second electrode 220 on the electrolyte 230, and a second current collector 210 on the second electrode 220. The electrolyte 230 may be a medium that delivers lithium ions between the first electrode 120 and the second electrode 220.

The first current collector 110 may include metal. The first current collector 110 may include copper, for example. The first current collector 110 may have a thickness of, for example, about 10 μm or less.

The first electrode 120 may be disposed on the first current collector 110. The first electrode 120 may serve as an anode. The first electrode 120 may be electrically connected to the first current collector 110. The first electrode 120 may include an anode active material, a conductive material, and a binder.

The electrolyte 230 may be disposed on the first electrode 120. The electrolyte 230 may be a solid electrolyte. The electrolyte 230 may be a sulfide-based solid electrolyte. The electrolyte 230 may be prepared through a dry process. The electrolyte 230 may include sulfide and polytetrafluoroethylene (PTFE). The electrolyte 230 may have a thickness of about 10 μm to about 99 μm.

The electrolyte 230 may be prepared through a dry process. The dry process uses sulfide solid powder and a binder without a liquid organic solvent, requiring no process of removing the liquid organic solvent, and thus the process may be simple. In the dry process, the electrolyte 230 may be easily prepared into a thin film.

The second electrode 220 may be disposed on the electrolyte 230. The second electrode 220 may serve as a cathode. The second electrode 220 may be electrically connected to the second current collector 210, which will be described later. The second electrode 220 may include a cathode active material, a conductive material, and a binder. The second electrode 220 may include a positive electrode active material and sulfide particles. The second electrode 220 may include the same sulfide particles as the solid electrolyte.

Referring to FIG. 1B, a lithium secondary battery 1b according to an embodiment of the inventive concept may include a first current collector 110, a first electrode 120 on the first current collector 110, an electrolyte 230 on the first electrode 120, a second electrode 220a on the electrolyte 230, and a second current collector 210 on the second electrode 220a. The electrolyte 230 may be a medium that delivers lithium ions between the first electrode 120 and the second electrode 220a.

The second electrode 220a may be a composite electrode. For example, the second electrode 220a may be a composite electrode to which sulfide particles and fiber powder are added. When the electrolyte 230 is a solid electrolyte, the electrolyte 230 is often obtained as the composite electrode 220a. The composite electrode 220a provides a benefit of improving contact with the electrolyte 230.

The second current collector 210 may include metal. The second current collector 210 may include aluminum, for example. The second current collector 210 may have a thickness of, for example, about 10 μm or less.

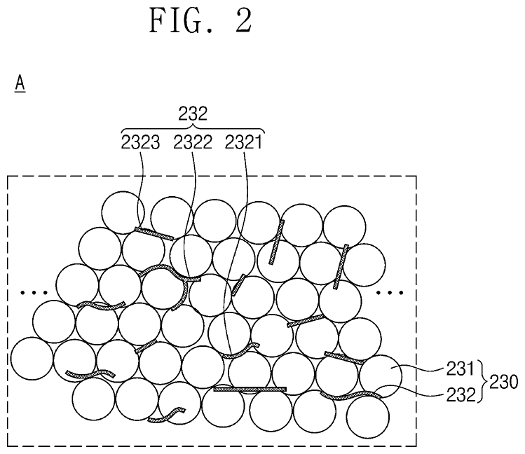

FIG. 2 is a view for describing a solid electrolyte according to an embodiment of the inventive concept, and is a view enlarging region A of FIG. 1.

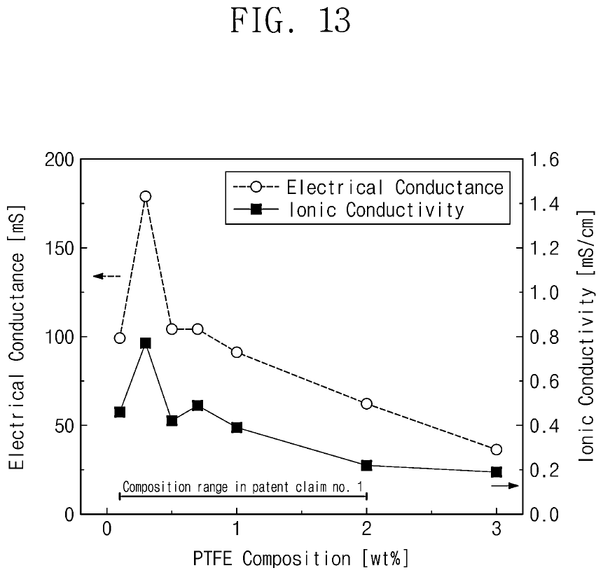

Referring to FIG. 2, the electrolyte 230 may include sulfide particles 231 and a fibril 232. The electrolyte 230 may include sulfide and polytetrafluoroethylene, and the polytetrafluoroethylene may be present at a weight of at least 0.1% and up to 2% of a weight of the sulfide. More detailed experimental results may be described in FIG. 13.

In an embodiment, the sulfide particles 231 may include LiPSCl. In an embodiment, the sulfide particles 231 may have a spherical shape.

The fibril 232 may include a first fibril 2321, a second fibril 2322, and a third fibril 2323. The first fibril 2321 may have a curved shape. The second fibril 2322 may have a curved shape with diverging branches, having a portion divided into two. The third fibril 2323 may have a straight shape. The shape of the fibril 232 is not limited thereto. The fibril 232 may include polytetrafluoroethylene (PTFE).

The fibril 232 may be positioned between a plurality of sulfide particles 231. The fibril 232 may be in contact with the sulfide particles 231. The fibril 232 may surround at least a portion of the sulfide particles 231 or may be in contact with at least a portion of the sulfide particles 231. The fibril 232 may have a thickness of less than about 0.5 μm. The fibril 232 may have a thin thread shape.

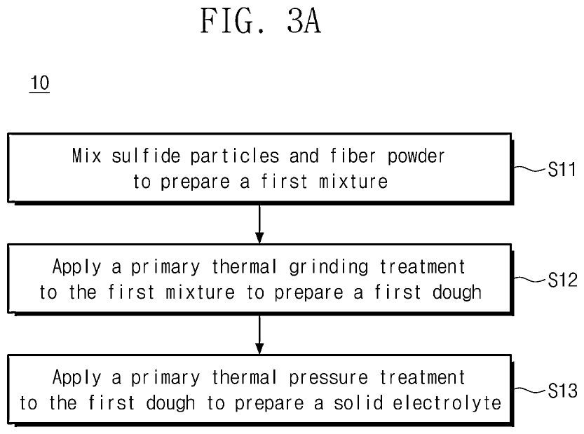

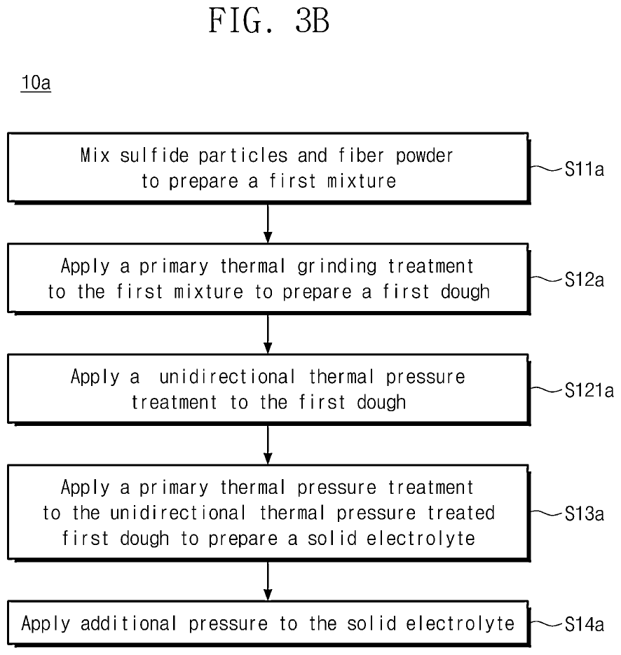

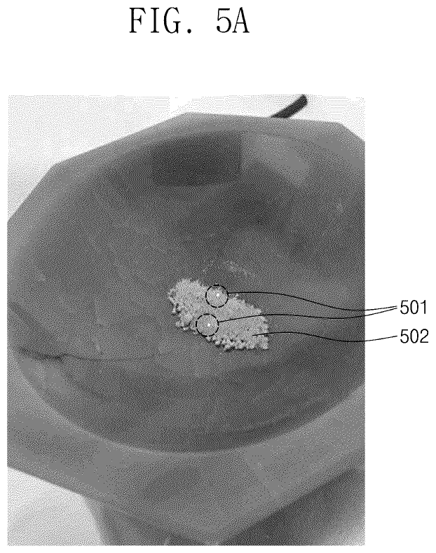

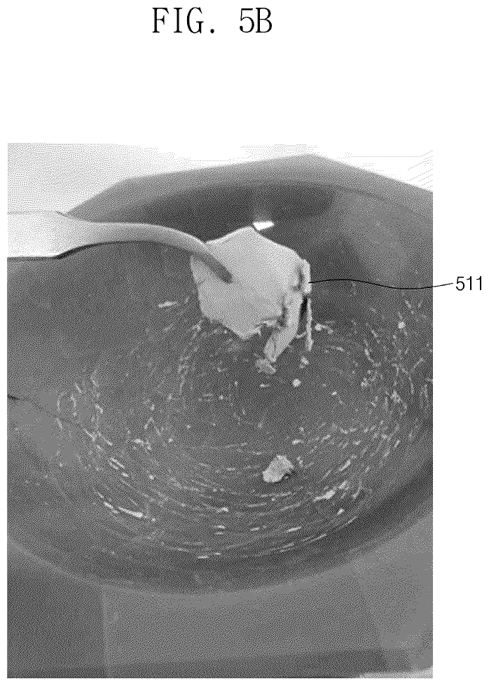

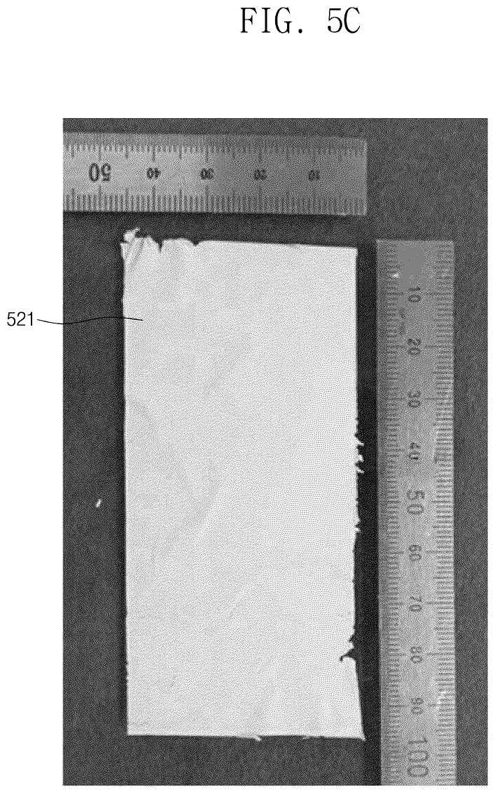

FIG. 3A is a flowchart showing a method for preparing a solid electrolyte according to an embodiment of the inventive concept. FIGS. 5A, 5B, and 5C are views for describing a solid electrolyte according to an embodiment of the inventive concept.

Referring to FIGS. 3A and 5A to 5C, a method 10 for preparing a solid electrolyte according to an embodiment of the inventive concept is provided. In this case, the solid electrolyte may be prepared through a dry manufacturing process in which no liquid solvent is used. The method 10 for preparing a solid electrolyte involves mixing sulfide particles 502 and fiber powder 501 to prepare a first mixture (S11), applying a primary thermal grinding treatment to the first mixture to prepare a first dough (S12), and applying a primary thermal pressure treatment to the first dough to prepare a solid electrolyte (S13).

The mixing of sulfide particles 502 and fiber powder 501 to prepare a first mixture (S11) may include mixing sulfide powder and polytetrafluoroethylene powder to prepare a first mixture. In the mixing of sulfide particles 502 and fiber powder 501 to prepare a first mixture (S11), the polytetrafluoroethylene powder may be present at a weight of at least 0.1% and up to 2% of a weight of the sulfide powder. The sulfide powder may include LiPSCl-based sulfide. In an embodiment, the mixing of sulfide particles 502 and fiber powder 501 to prepare a first mixture (S11) may include introducing LiPSCl-based Li₆PS₅Cl sulfide in an amount of 99.5 wt % and polytetrafluoroethylene in an amount of 0.5 wt %.

Referring to FIG. 5A, the sulfide particles 502 and the fiber powder 501 are present to be uncombined before mixing. In an embodiment, the sulfide particles 502 may be yellow Li₆PS₅Cl sulfide powder. In this case, the fiber powder 501 may be white polytetrafluoroethylene powder. Right after adding the Li₆PS₅Cl sulfide powder and the polytetrafluoroethylene powder at a ratio of 99.5 wt % and 0.5 wt %, respectively, the two types of powder may be present to be uncombined or unbonded.

The mixing may be performed using magnetic bars, and also performed through a variety of methods applying high energy, such as planetary mixers, planetary ball milling, ultrasonic processes, homogenizers, and centrifugal mixers.

The applying a primary thermal grinding treatment to the first mixture to prepare the first dough 511 (S12) may include grinding the first mixture at a temperature of about 60° C. to about 140° C. to prepare the first dough 511. The primary thermal grinding treatment may include grinding a heat treatment object at a temperature of about 60° C. to about 140° C.

The preparing of the first dough 511 after the primary thermal grinding treatment (S12) may include performing a grinding process using a mortar and pestle at 100° C. to make the first mixture into dough. In an embodiment, the preparing of the first dough 511 after the primary thermal grinding treatment (S12) involves adding only Li₆PS₅Cl sulfide powder and polytetrafluoroethylene powder, that is, solid powder, without adding a liquid solvent, and then grinding the mixture for 20 minutes to provide dough.

Referring to FIG. 5B, in an embodiment, the first dough 511 may be prepared by performing a grinding process using a mortar and pestle at 100° C. The first dough 511 may be in a state in which the sulfide particles 502 and the fiber powder 501 are mixed to turn into dough. In an embodiment, the first dough 511 may be in a state in which sulfide and polytetrafluoroethylene are mixed to turn into dough. In an embodiment of the inventive concept, dough may be defined as an elastic solid mass.

When the dough is kneaded like the first dough 511 of FIG. 5B, once the dough is kneaded and held together, the dough may not fall even when lifted with tweezers.

That is, unlike the sulfide particles 502 and the fiber powder 501 in FIG. 5A, the sulfide particles 502 and the fiber powder 501 in FIG. 5B may be in a state of being bonded by the thermal grinding process.

The applying a primary thermal pressure treatment to the first dough to prepare a solid electrolyte (S13) may include pushing the first dough into an empty space between a plurality of rotating press rolls having a temperature of about 70° C. to about 150° C. The applying a primary thermal pressure treatment to the first dough to prepare a solid electrolyte (S13) may include pushing the first dough into an empty space at least two times while reducing the size of the empty space between the press rolls. In this case, the thickness of the dough may be reduced by pushing the first dough into the empty space while reducing the size of the empty space in the order of, for example, 100 μm, 75 μm, 50 μm, and 30 μm.

FIG. 3B is a flowchart showing a method 10a for preparing a solid electrolyte according to an embodiment of the inventive concept. Hereinafter, content overlapping the above descriptions will not be given.

Referring to FIGS. 3B, and 5A to 5C, a method 10a for preparing a solid electrolyte according to an embodiment of the inventive concept is provided. In this case, the solid electrolyte may be prepared through a dry manufacturing process in which no liquid solvent is used. The method 10a for preparing a solid electrolyte may include mixing sulfide particles and fiber powder to prepare a first mixture (S11a), applying a primary thermal grinding treatment to the first mixture to prepare a first dough (S12a), applying an unidirectional thermal pressure treatment to the first dough (S121a), applying a primary thermal pressure treatment to the first dough after the unidirectional thermal pressure treatment to prepare a solid electrolyte (S13), and applying additional pressure to the solid electrolyte (S14).

The mixing of the sulfide particles 502 and the fiber powder 501 to prepare the first mixture (S11a) in the method 10a for preparing a solid electrolyte may be the same as the mixing of the sulfide particles and the fiber powder to prepare the first mixture (S11) in the method 10 for preparing a solid electrolyte.

The applying a primary thermal grinding treatment to the first mixture to prepare the first dough (S12a) in the method 10a for preparing a solid electrolyte may be the same as the applying a primary thermal grinding treatment to the first mixture to prepare the first dough (S12) in the method 10 for preparing a solid electrolyte.

The applying a primary thermal pressure treatment to the first dough after the unidirectional thermal pressure treatment to prepare a solid electrolyte (S13a) in the method 10a for preparing a solid electrolyte may be the same as the applying a primary thermal pressure treatment to the first dough to prepare a solid electrolyte (S13).

After the preparing the first dough (S12a), the applying the unidirectional thermal pressure treatment to the first dough (S121a) may be additionally performed before the applying the primary heat pressure treatment to the first dough to prepare a solid electrolyte (S13a). The applying the unidirectional thermal pressure treatment to the first dough (S121a) may include pressing the first dough in one direction at about 70° C. to about 130° C. to make the first dough flat. In an embodiment, the applying the unidirectional thermal pressure treatment to the first dough (S121a) may include pressing the first dough in one direction at 100° C. to make the first dough flat. In this case, the subsequent stage of the applying the primary heat pressure treatment to the first dough to prepare a solid electrolyte (S13a) may be performed more easily.

The applying of additional pressure to the solid electrolyte (S14a) may be performed after the applying the primary thermal heat pressure treatment to the first dough after the unidirectional thermal pressure treatment to prepare the solid electrolyte (S13a). The applying of additional pressure to the solid electrolyte (S14a) may including pressurizing at a pressure of about 200 MPa to about 600 MPa at about 70° C. to about 130° C. In an embodiment, the applying of additional pressure to the solid electrolyte (S14a) may include applying pressure in one direction at 100° C. and 588 MPa for 10 seconds.

Referring to FIG. 5C, a solid electrolyte after the applying of additional pressure to the solid electrolyte (S14a) is provided. For example, the solid electrolyte may be in the form of a solid electrolyte sheet. In an embodiment, a sheet prepared on a laboratory scale may be about 4.5 cm wide and about 9.6 cm long. In an embodiment, when large-scale manufacturing equipment is applied, increasing the size of the solid electrolyte sheet may be easily achieved.

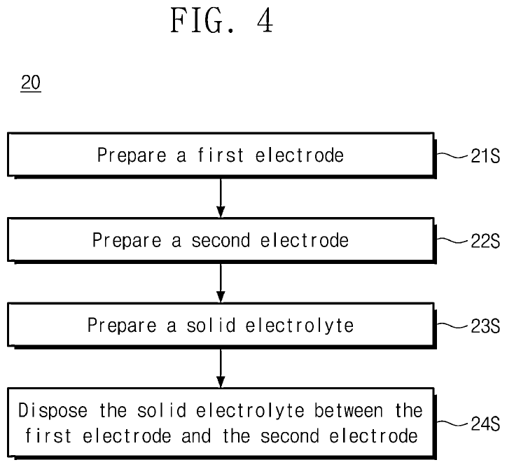

FIG. 4 is a flowchart showing a method 20 for manufacturing a secondary battery according to an embodiment of the inventive concept. The method 20 for manufacturing a secondary battery may include preparing a first electrode (21S), preparing a second electrode (22S), and disposing a solid electrolyte between the first electrode and the second electrode (24S).

In an embodiment, the disposing of the solid electrolyte between the first electrode and the second electrode (24S) may include disposing the solid electrolyte prepared through in the method 10 for preparing a solid electrolyte in FIG. 3A between the first electrode and the second electrode.

In an embodiment, the disposing of the solid electrolyte between the first electrode and the second electrode (24S) may include disposing the solid electrolyte prepared through in the method 10a for preparing a solid electrolyte in FIG. 3B between the first electrode and the second electrode.

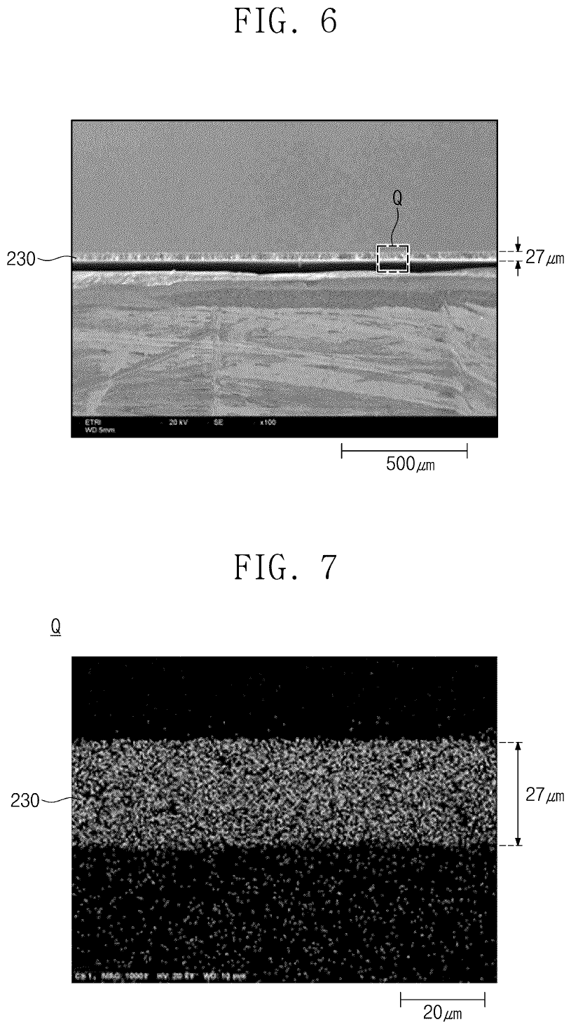

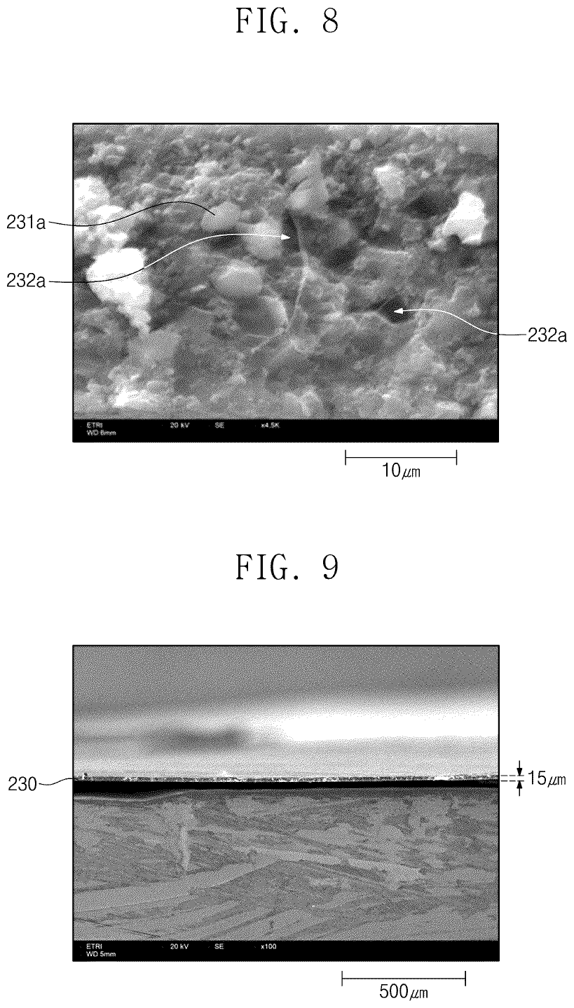

FIG. 6 is a scanning electron microscope (SEM) image of a solid electrolyte prepared according to an embodiment of the inventive concept. FIG. 7 is a scanning electron microscope (SEM) image of a solid electrolyte prepared according to an embodiment of the inventive concept, and is a view enlarging region Q of FIG. 6. FIG. 8 is a scanning electron microscope (SEM) image of a solid electrolyte prepared according to an embodiment of the inventive concept.

Referring to FIG. 6, the results of SEM observation at a magnification of 100 times may be provided. The solid electrolyte 230 may have a thickness of about 27 μm. In an embodiment, the solid electrolyte 230 may have a thickness of about 27 m or less. The solid electrolyte 230 may be prepared using a dry manufacturing process.

Referring to FIG. 7, after enlarging portion Q of FIG. 6 at a magnification of 1500 times, the results of EDAX observation for elemental sulfur (element symbol: S) may be provided. White elemental sulfur may be intensively observed in an about 27 μm thick region of the solid electrolyte 230.

Meanwhile, elemental sulfur may be observed sparsely in a lower portion of the 27 μm thick region of the solid electrolyte 230 in FIG. 7. For example, this may be because when a flat dough-shaped solid electrolyte 230 is attached to a sample holder and placed in a SEM chamber and then the SEM chamber is vacuumed, the solid electrolyte 230 is tilted on the sample holder to create an empty space. That is, it is seen that the sparse portion is a lower surface of the solid electrolyte 230.

Referring to FIG. 8, an SEM image of the solid electrolyte 230 observed at a magnification of 4500 times is provided. A number of round-shaped sulfide particles 231a may be observed. A fibril 232a having a thickness of less than about 0.5 μm and a thin thread shape is observed. In more detail, the fibril 232a of FIG. 4C has a curved shape, and one strand of the fibril 232a has a thickness of about 0.1 μm. The fibril 232a may be polytetrafluoroethylene. The polytetrafluoroethylene may become fiberized and change into a thread form when subjected to high shearing force. Polytetrafluoroethylene powder added at a rate of 0.5 wt % in the solid electrolyte 230 is subjected to high shear stress by the solid electrolyte 230 manufacturing process 10 or 10a, and thus the thread-shaped fibril 232a may be observed. The fibril 232a may surround at least a portion of the sulfide particles 231a or may be in contact with at least a portion of the sulfide particles 231a. Accordingly, cohesion between the sulfide particles 231a is generated, and accordingly, the sulfide particles 231a and the fibril 232a may be in the form of dough. Accordingly, a solid electrolyte manufacturing process allowing a thickness of several tens of m may also be achievable.

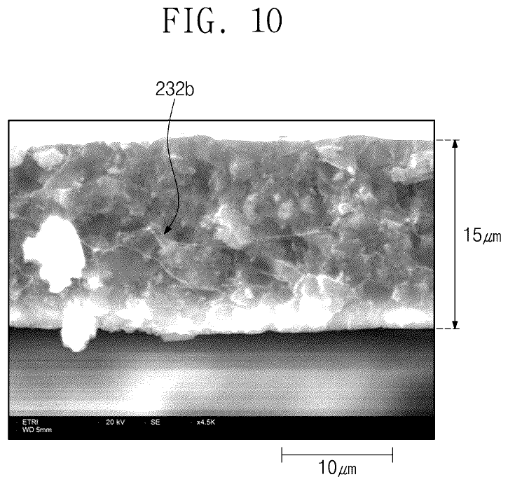

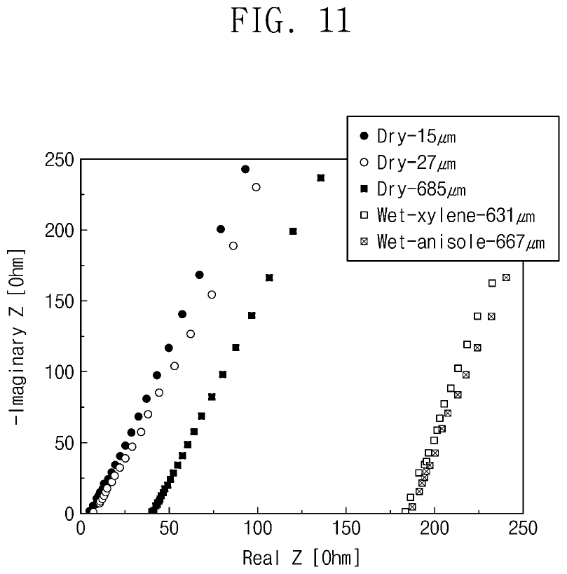

FIG. 9 is a scanning electron microscope (SEM) image of a solid electrolyte prepared according to an embodiment of the inventive concept. FIG. 10 is a scanning electron microscope (SEM) image of a solid electrolyte prepared according to an embodiment of the inventive concept.

Referring to FIG. 9, the results of SEM observation at a magnification of 100 times may be provided. The solid electrolyte 230 may have a thickness of about m. The solid electrolyte 230 may be prepared using a dry manufacturing process that uses no liquid solvent, as shown in FIGS. 3A and 3B.

Referring to FIG. 10, the results of SEM observation at a magnification of 4500 times may be provided. The solid electrolyte 230 may have a thickness of about 15 μm. A fibril 232b having a thickness of about 0.1 μm may be observed in the region of solid electrolyte 230.

FIG. 11 is a graph for describing electrical resistance and conductance properties of a solid electrolyte prepared according to an embodiment of the inventive concept.

Referring to FIG. 11, the results of comparing electrical resistance and conductance according to the thickness of the solid electrolyte prepared through a dry manufacturing method and according to a dry manufacturing method or a wet manufacturing method of the solid electrolyte are provided. The conductance may be defined as a reciprocal of the electrical resistance.

In order to determine the effects according to the thickness of the solid electrolyte, the results of a total of three samples, 27 μm thick (Dry-27 μm), 15 μm thick (Dry-15 μm), and 685 μm thick (Dry-685 μm), are compared.

In order to compare the electrical resistance and conductance according to the dry manufacturing method or the wet manufacturing method of the solid electrolyte, the results of a total of three solid electrolyte samples, Dry-685 m, Wet-xylene-631 μm, and Wet-anisole-667 μm, are compared. In order to compare the results according to the dry manufacturing method or the wet manufacturing method of the solid electrolyte, the effects from the thickness is intended to be excluded as much as possible, and for this purpose, the manufacturing process may be performed to obtain a solid electrolyte having a thickness of about 600 μm to about 700 μm. In both dry and wet manufacturing methods, sulfide Li₆PS₅Cl may be used as sulfide particles. In the dry manufacturing method, polytetrafluoroethylene may be used as fiber powder. In the wet manufacturing method, nitrile butadiene rubber (NBR) may be used as a binder. Sulfide and polytetrafluoroethylene, and sulfide and NBR may be in a weight ratio of about 99.5 wt % and about 0.5 wt %, respectively.

The wet manufacturing method involves completely mixing the Li₆PS₅Cl sulfide and the NBR binder in each of the two types of liquid organic solvents, xylene and anisole, and then removing the liquid solvents.

To prepare samples for measuring the electrical resistance and conductance in FIG. 11, titanium (element symbol: Ti) may be used as an electrode. For measurements, an alternating voltage may be applied using a frequency response analyzer (Solartron HF 1225, AMETEK Scientific Instruments) from a low frequency of 10⁻¹ hertz (Hz) to a high frequency of 105 hertz.

Comparing the results of Dry-15 μm, Dry-27 μm, and Dry-685 μm in FIG. 11 shows that the electrical resistance decreases and the conductance increases in the order of 685 μm, 27 μm, and 15 μm in the dry manufacturing process (Table 1). As described above, the smaller the solid electrolyte thickness is, the higher the energy density and power density, and Table 1 shows that low electrical resistance and high conductance may act as factors.

TABLE 1

| Method/Thickness [μm] | Dry/685 | Dry/27 | Dry/15 |
|---|---|---|---|
| Electrical resistance [Ω] | 41 | 6.4 | 4.3 |
| Conductance [mS] | 24 | 156 | 232 |

### <Electrical Resistance and Conductance According to Thickness of Dry Solid Electrolyte in FIG. 11>

TABLE 2

| Method/Solid | | | |
|---|---|---|---|
| electrolyte thickness [μm] | Dry/685 | Wet/631 | Wet/667 |
| Liquid solvent | Not used | Xylene | Anisole |
| Sulfide:Binder [wt %] | 99.5:0.5 | 99.34:0.66 | 99.07:0.93 |
| Electrical resistance [Ω] | 41 | 182 | 185 |
| Conductance [mS] | 24 | 5 | 5 |

### <Electrical Resistance and Conductance According to Dry Manufacturing Method or Wet Manufacturing Method of Solid Electrolyte in FIG. 11>

Comparing the results of Dry-685 μm, Wet-xylene-631 μm, and Wet-anisole-667 μm in FIG. 11 shows that the dry solid electrolyte has much smaller electrical resistance and much greater conductance than the wet solid electrolyte (Table 2).

This shows that the benefits of the solid electrolyte prepared through the dry manufacturing method compared to the wet manufacturing method may be small electrical resistance and high conductance, in addition to the simple process and easy thickness reduction.

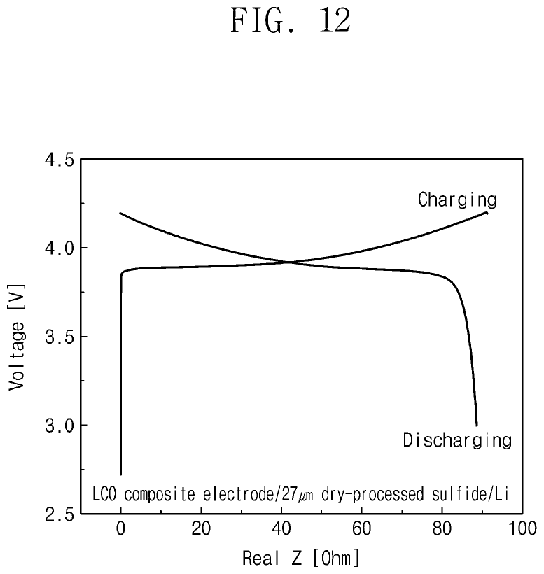

FIG. 12 is a graph for describing the charging and discharging characteristics of a lithium secondary battery manufactured using a solid electrolyte prepared according to an embodiment of the inventive concept.

Referring to FIG. 12, the charge/discharge characteristics of a lithium secondary battery manufactured using the solid electrolyte of the inventive concept are shown. The manufactured lithium secondary battery has the same structure as the lithium secondary battery 1 of FIG. 1, and the method for preparing a solid electrolyte used may be the same as the preparation method 10 of FIG. 3A or the preparation method 10a of FIG. 3B.

In an embodiment, the first electrode 120 may be lithium (element symbol: Li) having a thickness of 40 μm, the second electrode 220 may be a lithium cobalt oxide (LCO) composite electrode, and the solid electrolyte 230 may have a thickness of about 27 μm. The lithium secondary battery to which the solid electrolyte of an embodiment of the inventive concept is applied may undergo charging and discharging operations. Accordingly, it is seen that the dry-processed solid electrolyte 230 of an embodiment of the inventive concept may be applied and used in the lithium secondary battery.

FIG. 13 is a graph for describing the characteristics of a secondary battery including a solid electrolyte prepared according to an embodiment of the inventive concept.

Referring to FIG. 13, the electrical conductance and ionic conductivity of a secondary battery in a case where polytetrafluoroethylene (PTFE) is used as fiber powder in the solid electrolyte of an embodiment of the inventive concept are shown. The performance of the secondary battery is proportional to the values of electrical conductance and ionic conductivity. The electrical conductance and ionic conductivity may have higher values in the polytetrafluoroethylene composition of 0.1 wt % to 2 wt % than in other ranges. In the case of the polytetrafluoroethylene composition of 0 wt %, the first dough is not obtained even when primary thermal grinding treatment is performed.

According to an embodiment of the inventive concept, an electrolyte composition and a lithium secondary battery including the same may have improved thermal safety. The lithium secondary battery may have improved electrochemical properties.

What is claimed is:

1. A lithium secondary battery comprising:
a first electrode;
a second electrode spaced apart from the first electrode;
a solid electrolyte disposed between the first electrode and the second electrode,
wherein the solid electrolyte includes:
a fibril; and
a plurality of sulfide particles,
the fibril includes polytetrafluoroethylene,
the fibril is in contact with at least some of the sulfide particles,
the polytetrafluoroethylene is present at a weight of about 0.1% to about 2% of a weight of the sulfide, and
the solid electrolyte has a thickness of about 10 μm to about 99 μm.

2. The lithium secondary battery of claim 1, wherein the fibril has a thickness of less than about 0.5 μm and has a thin thread shape.

3. The lithium secondary battery of claim 1, wherein the sulfide comprises LiPSCl sulfide.

4. The lithium secondary battery of claim 1, wherein the solid electrolyte is prepared through a dry manufacturing method.

5. The lithium secondary battery of claim 1, wherein the first electrode is a negative electrode, and the second electrode is a positive electrode.

6. The lithium secondary battery of claim 1, wherein the second electrode comprises a positive electrode active material and sulfide particles, and
the second electrode comprises the same sulfide particles as the solid electrolyte.

7. The lithium secondary battery of claim 1, wherein the fibril has at least any one of a straight shape, a curved shape, or a curved shape with diverging branches.

8. The lithium secondary battery of claim 1, wherein the sulfide is Li₆PS₅Cl,
the polytetrafluoroethylene is in an amount of 0.5 wt % in the mixture of the sulfide and polytetrafluoroethylene, and
the sulfide is in an amount of 99.5 wt % in the mixture of the sulfide and polytetrafluoroethylene.

9. A method for manufacturing a lithium secondary battery, the method comprising:
preparing a first electrode;
preparing a second electrode;
preparing a solid electrolyte; and
disposing the solid electrolyte between the first electrode and the second electrode,
wherein the preparing of the solid electrolyte includes:
mixing sulfide particles and fiber powder to prepare a first mixture;
applying a primary thermal grinding treatment to the first mixture to prepare a first dough; and
applying a primary thermal pressure treatment to the first dough to prepare the solid electrolyte.

10. The method of claim 9, wherein the mixing of the sulfide particles and the fiber powder to prepare the first mixture comprises mixing LiPSCl-based Li₆PS₅Cl sulfide in an amount of 99.5 wt % and polytetrafluoroethylene in an amount of 0.5 wt %.

11. The method of claim 9, wherein the applying the primary thermal grinding treatment to the first mixture to prepare the first dough comprises grinding the first mixture at a temperature of about 60° C. to about 140° C. to prepare the first dough.

12. The method of claim 9, wherein the applying the primary thermal grinding treatment to the first mixture to prepare the first dough comprises grinding the first mixture with a mortar and pestle at 100° C. to change the first mixture into the first dough.

13. The method of claim 9, wherein the applying the primary thermal pressure treatment to the first dough to prepare the solid electrolyte comprises pushing the first dough into an empty space between a plurality of rotating press rolls having a temperature of about 70° C. to about 150° C.

14. The method of claim 13, wherein the applying the primary thermal pressure treatment to the first dough to prepare the solid electrolyte comprises pushing the first dough into the empty space at least two times while reducing the size of the empty space between the press rolls.

15. The method of claim 9, wherein the solid electrolyte comprises:
a fibril; and
a plurality of sulfide particles,
the fibril comprises polytetrafluoroethylene,
the fibril is in contact with at least some of the sulfide particles,
the polytetrafluoroethylene is present at a weight of about 0.1% to about 2% of a weight of the sulfide, and
the solid electrolyte has a thickness of about 10 μm to about 99 μm.

16. The method of claim 9, wherein the preparing of the solid electrolyte further comprises applying additional pressure to the solid electrolyte after applying the primary thermal pressure treatment to the first dough to prepare the solid electrolyte, and
the applying additional pressure to the solid electrolyte comprises applying pressure at a pressure of about 200 MPa to about 600 MPa at about 70° C. to about 130° C.

17. The method of claim 9, wherein the preparing of the solid electrolyte further comprises applying a unidirectional thermal pressure treatment to the first dough after applying the primary thermal grinding treatment to the first mixture to prepare the first dough, and
the unidirectional thermal pressure treatment comprises pressing the first dough in one direction at about 70° C. to about 130° C. to make the first dough flat.

18. The method of claim 9, wherein the fiber powder comprises polytetrafluoroethylene powder, and
the polytetrafluoroethylene powder is at a weight of about 0.1% to about 2% of a weight of the sulfide powder.

19. A method for preparing a solid electrolyte, the method comprising:
mixing sulfide particles and fiber powder to prepare a first mixture;
applying a primary thermal grinding treatment to the first mixture to prepare a first dough;
applying a unidirectional thermal pressure treatment to the first dough;
applying a primary thermal pressure treatment to the unidirectional thermal pressure treated first dough to prepare a solid electrolyte; and
applying additional pressure to the solid electrolyte,
wherein the applying a primary thermal grinding treatment to the first mixture to prepare a first dough includes grinding the first mixture at a temperature of about 60° C. to about 140° C.,
the applying the unidirectional thermal pressure treatment to the first dough includes pressing the first dough in one direction at about 70° C. to about 130° C. to make the first dough flat, and
the applying the primary thermal pressure treatment to the unidirectional thermal pressure treated first dough to prepare a solid electrolyte includes pushing the first dough into an empty space between a plurality of rotating press rolls having a temperature of about 70° C. to about 150° C.

20. The method of claim 19, wherein the solid electrolyte has a thickness of about 27 μm or less after the applying of additional pressure to the solid electrolyte.
